(19) United States
(12) Patent Application Publication
(10) Pub. No.: US 2011/0064050 A1
(43) Pub. Date: Mar. 17, 2011

(54) BROADCAST SERVICE HANDOVER

(75) Inventors: Catherine M. Livet, Montreal (CA); Michelle Perras, Montreal (CA); Juan Carlos Zuniga, Montreal (CA)

(73) Assignee: INTERDIGITAL PATENT HOLDINGS, INC., Wilmington, DE (US)

(21) Appl. No.: 12/879,663

(22) Filed: Sep. 10, 2010

Related U.S. Application Data
(60) Provisional application No. 61/241,754, filed on Sep. 11, 2009.
(60) Provisional application No. 61/243,753, filed on Sep. 18, 2009.

(51) Int. Cl. H04W 36/00

(52) U.S. Cl. 370/331

(57) ABSTRACT

A wireless transmit/receive unit (WTRU) may receive a broadcast service via a broadcast system. The broadcast service may be handed over from the broadcast system to a second broadcast system, and the WTRU may receive the broadcast service via the second broadcast system. The WTRU and/or the broadcast system may change broadcast service configuration parameters (such as video encapsulation format, video codec, frame rate, audio codec) to receive and/or display broadcast service data received via the second broadcast system. Additionally, a WTRU may receive a broadcast service via a broadcast system that includes more than one broadcast transmission network. The broadcast service may be handed over from a first broadcast transmission network in the broadcast system to a second broadcast transmission network in the broadcast system. The WTRU may change broadcast service configuration parameters to receive and/or display broadcast service data received via the second broadcast transmission network.

### CROSS REFERENCE TO RELATED APPLICATIONS

This application claims the benefit of U.S. Provisional Application No. 61/241,754, filed on Sep. 11, 2009, and U.S. Provisional Patent Application No. 61/243,753, filed on Sep. 18, 2009, each of which is incorporated by reference as if fully set forth herein.

### TECHNICAL FIELD

The subject matter disclosed herein relates to wireless communications.

### BACKGROUND

A number of broadcast technologies have been developed to deliver media content such as audio, video, and other types of content. Examples of these technologies include Digital Video Broadcasting (DVB), MediaFLO, Open Mobile Alliance (OMA) Mobile Broadcast Services Enabler Suite (BCAST), European Telecommunications Standards Institute (ETSI) IP Television (IPTV), Third Generation Partnership Project (3GPP) Multimedia Broadcast Multicast Service (MBMS), and Digital Multimedia Broadcasting (DMB). Using a broadcast system (as opposed a system based on unicast technology), high-bandwidth media content may be delivered in a broadcast service from a single originating source to many users.

A wireless transmit/receive unit (WTRU) may receive a broadcast service from a broadcast system and display the media content to a user. For various reasons (e.g., a degradation on quality of service, or the WTRU has left the current coverage area), it may be desirable to handover the broadcast service to a different broadcast system that is based on a different technology from the current broadcast system. Current technologies address some aspects of how this type of handover may be performed. By using technology based on Institute of Electrical and Electronics Engineers (IEEE) 802.21 (also referred to as IEEE Media Independent Handover (MIH)), for example, a WTRU may perform a handover between radio access networks that are based on different types of technologies. Current approaches do not, however, address service- and application-level aspects of this type of handover. For example, different broadcast systems may require different video encapsulation formats, video codecs, or audio codecs. If a WTRU receives a broadcast service from a MediaFLO system (which may use a FLO Sync Layer for video encapsulation) and performs a handover to a DVB-H system (which may use a video encapsulation format based on Real Time Protocol (RTP)), current technologies do not address how the switch in video encapsulation formats should be performed. Accordingly, new technologies are required that address these shortcomings, as well as other shortcomings, in the current technologies.

### SUMMARY

A method for use in a wireless transmit/receive unit (WTRU) may include receiving a broadcast service via a first broadcast transmission network in a broadcast system, and determining whether the broadcast service is established in a second broadcast transmission network in the broadcast system. The second broadcast transmission network may be based on a different radio access technology from the first broadcast transmission network. The method may further include initiating establishment of the broadcast service in the second broadcast transmission network in response to a determination that the broadcast service is not established in the second broadcast transmission network. The method may further include performing a handover to the second broadcast transmission network and receiving the broadcast service via the second broadcast transmission network.

A WTRU may include at least one lower layer component configured to receive a broadcast service via a first broadcast transmission network in a broadcast system. The WTRU may also include a processor configured to determine whether the broadcast service is established in a second broadcast transmission network in the broadcast system. The second broadcast transmission network may be based on a different radio access technology from the first broadcast transmission network. The at least one lower layer component may be further configured to initiate establishment of the broadcast service in the second broadcast transmission network in response to a determination that the broadcast service is not established in the second broadcast transmission network. The at least one lower layer component may be further configured to perform a handover to the second broadcast transmission network and to receive the broadcast service via the second broadcast transmission network.

A method for use in a wireless transmit/receive unit (WTRU) may include receiving a broadcast service via a first broadcast system and displaying data from the broadcast service in a first media application based on broadcast service configuration data related to the first broadcast system. The method may further include performing a handover from the first broadcast system to a second broadcast system. The second broadcast system may be based on a different technology from the first broadcast system. The method may further include receiving the broadcast service via the second broadcast system and displaying data from the broadcast service in a second media application based on broadcast service configuration data related to the second broadcast system.

### BRIEF DESCRIPTION OF THE DRAWINGS

A more detailed understanding may be had from the following description, given by way of example in conjunction with the accompanying drawings wherein:

FIG. 1 shows an example architecture for the handover of a broadcast service between broadcast transmission networks;

FIG. 2 shows an example architecture for the handover of a broadcast service between broadcast systems;

FIGS. 3A-3B show a method for the WTRU-initiated handover of a broadcast service between broadcast transmission networks;

FIGS. 4A-4B show a method for the network-initiated handover of a broadcast service between broadcast transmission networks;

FIG. 5 shows a method for the handover of a broadcast service between two broadcast systems; and

FIG. 6 is a diagram of an example communications system in which the features described with reference to FIGS. 1-5 may be implemented.

### DETAILED DESCRIPTION

When referred to hereafter, the terminology “wireless transmit/receive unit (WTRU)” includes but is not limited to a user equipment (UE), a mobile station, a mobile terminal, a fixed or mobile subscriber unit, a pager, a cellular telephone, a personal digital assistant (PDA), a computer, or any other type of device capable of operating in a wireless environment. When referred to hereafter, the terminology “base station” includes but is not limited to a Node-B, a site controller, an access point (AP), or any other type of interfacing device capable of operating in a wireless environment. When referred to hereafter, the terminology terms “network node,” “network element,” and “network component” refer to but are not limited to any electronic device that is attached to a communications network and is capable of sending and/or receiving data.

When referred to hereafter, the terminology “broadcast service” refers to any service for the transmission of wireless data from one transmission source to multiple receiving devices. Broadcast services include but are not limited to services based on technologies such as MBMS, DMB, DVB, MediaFLO, OMA BCAST, or ETSI IPTV technologies. A broadcast service may deliver data that includes, for example, audio streams, video streams, mobile televisions streams, Internet Protocol (IP)-based datacast streams, and/or other types of data.

When referred to hereafter, the term “broadcast service configuration data” refers to data that relates to the encoding, decoding, and/or display of data provided by a broadcast service. Broadcast service configuration data may include, for example, data that indicates a video encapsulation format, video codec, frame rate, audio codec, and/or other parameters that describe how data is encoded, decoded, and/or displayed. When MediaFLO is used, for example, broadcast service configuration parameters may indicate a FLO Sync Layer for video encapsulation, Enhanced H.264 for a video codec, a variable frame rate of up to thirty frames per second, and High-Efficiency Advanced Audio Coding (HE-ACC) v2 for an audio codec. When DVB-H is used, broadcast service configuration parameters may indicate Real Time Protocol (RTP) Payload Format for H.264 Video (RFC 3984) for video encapsulation, H.264 as a video codec, a frame rate of between fifteen and thirty frames per second, and HE-ACC v2 for an audio codec. When MBMS is used, broadcast service configuration parameters may indicate RTP Payload Format for H.264 Video (RFC 3984) for video encapsulation, H.264 as a video codec, a frame rate of fifteen to thirty frames per second, and audio codecs such as Adaptive Multi-Rate Narrowband (AMR-NB), Adaptive Multi-Rate Wideband (AMR-WB), Enhanced Adaptive Multi-Rate Wideband (EAMR-WB), and/or HE-ACC v2.

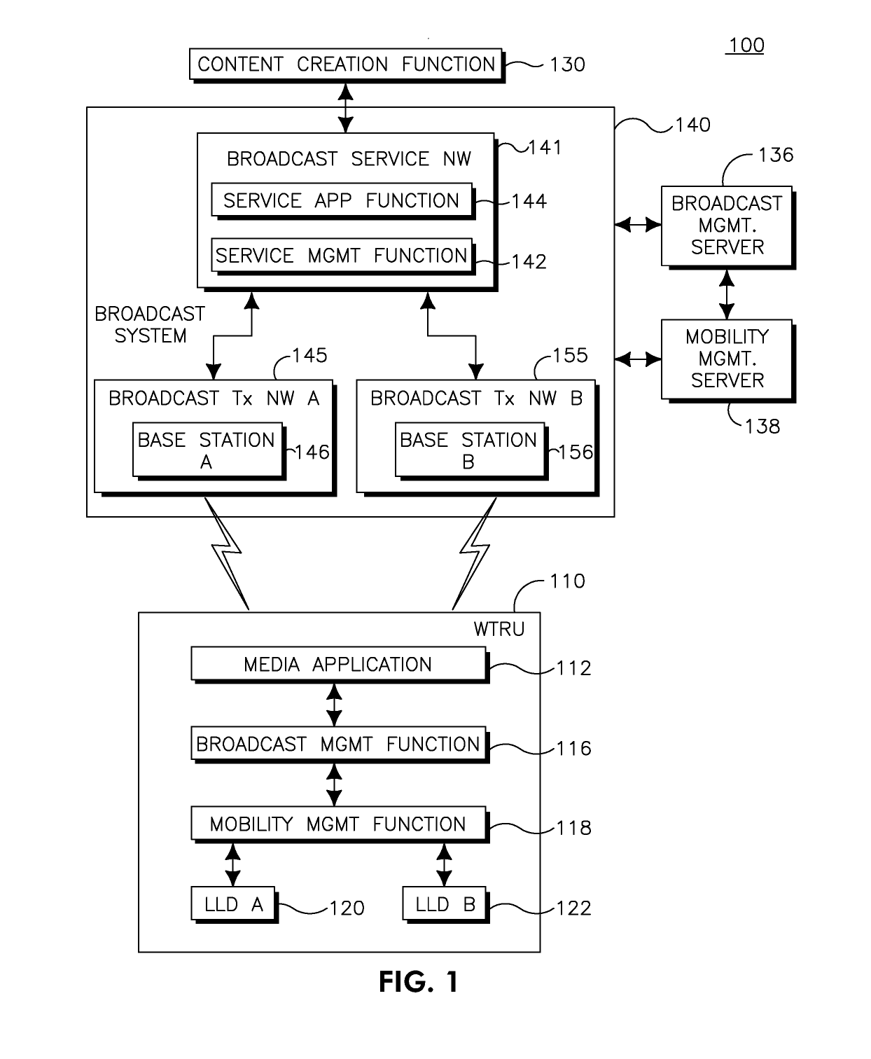

When referred to hereafter, the term “broadcast system” refers to a collection of one or more networks for the communication of broadcast service data. A broadcast system may include a broadcast service network and a broadcast transmission network. The term “broadcast service network” refers to a network that manages service- and application-level aspects of providing a broadcast service, such as but not limited to the management of user access to service applications, and/or encoding data with appropriate video and/or audio codecs. The term “broadcast transmission network” refers to a network that may perform functionality such as the broadcast transmission of broadcast service data over an air interface. A broadcast system may include multiple broadcast transmission networks that broadcast data that is received from a single broadcast service network. Examples of broadcast systems, broadcast service networks, and broadcast transmission networks are described below with reference to FIGS. 1-6.

As used herein, the terms “software module” and “firmware module” include, but are not limited to, an executable program, a function, a method call, a procedure, a routine or sub-routine, an object, a data structure, or one or more executable instructions. A “software module” or a “firmware module” may be stored in one or more computer-readable media.

When referred to hereafter, the terminology “lower layer device” is a device that implements layer one and/or layer two functionality according to a radio access technology. A lower layer device (LLD) may be implemented as one or more circuits, one or more software modules, one or more firmware modules, or as any combination of circuits, software modules, and/or firmware modules. An LLD may be, for example, a transceiver or one or more components in a transceiver. Alternatively or additionally, an LLD for implementing a downlink-only radio access technology such as DVB-H or MediaFLO may be or include a receiver.

FIG. 1 shows an example architecture 100 for the handover of a broadcast service between two broadcast transmission networks 145, 155. The architecture 100 includes a content creation function 130, a broadcast management server 136, a mobility management server 138, a broadcast system 140, and a wireless transmit/receive unit (WTRU) 110. The broadcast system 140 includes a broadcast service network 141 and two broadcast transmission networks (Broadcast Transmission Network A 145 and Broadcast Transmission Network B 155). The broadcast service network 141 may manage service- and application-level aspects of broadcast services, while the broadcast transmission networks 145, 155 may perform function such as the radio transmission of broadcast service data to the WTRU 110. As will be described in further detail below, the broadcast system 140 may provide a broadcast service to the WTRU 110, and the broadcast service may be handed over between the two broadcast transmission networks 145, 155.

The broadcast service network 141 may perform functionality related to the management of broadcast service data and the preparation of broadcast service data for transmission to the WTRU 110, such as service purchase and protection (SPP) and the management of an electronic service guide (ESG) that described the broadcast programming offered by the broadcast system 140. The broadcast service network 141 may include a service application function 144 and service management function 142. The broadcast service network 141 may receive content data (e.g., video and/or audio data to be broadcast to the WTRU 110) from the content creation function 130. The service application function 144 may perform functionality such as aggregating the received content data (with other data that may be received from other content creation functions (not depicted)), encoding streaming content with appropriate video and/or audio codecs, and generating service description metadata such as title, genre, and/or time information. The service management function 142 may perform security functionality, such as the management of user access to service applications. The service management function 142 may also perform functionality related to the transmission of broadcast data, such as making determinations regarding suitable bearers and adapting broadcast data to available bearers in the broadcast transmission networks 145, 155, managing service configuration and resource allocation, assigning services (based on factors such as location and bandwidth), and/or scheduling services over time. The broadcast service network 141 may be based on technologies such as OMA BCAST technology, Digital Video Broadcasting-Handheld (DVB-H) IP Datacast (IPDC) technology, MBMS technology, ETSI IPTV technology, or any other appropriate technology for the management of service- and/or application-level aspects of broadcast communications.

The broadcast transmission networks 145, 155 may receive broadcast service data from the broadcast service network 141 and broadcast the broadcast service data to the WTRU 110. Broadcast Transmission Network A 145 may include a core network (not depicted), and/or a radio access network (not depicted) of which Base Station A 146 may be a part. The core network, radio access network, and/or Base Station A 146 may be based on technology such as Universal Mobile Telecommunications System (UMTS), UMTS Terrestrial Radio Access Network (UTRAN), GSM (Global System for Mobile Communications (GSM), GSM Enhanced Data Rates For GSM Evolution (EDGE) Radio Access Network (GERAN), DVB-H, MediaFLO, MBMS, or any other appropriate technology. Broadcast Transmission Network B 155 may based on similar technologies and/or perform analogous functions as those described above with reference to Broadcast Transmission Network A 145.

Broadcast Transmission Network A 145 and Broadcast Transmission Network B 155 may based on different technologies. As one example, Broadcast Transmission Network A 145 may be based on UMTS/MBMS technology, while Broadcast Transmission Network B 155 may be based on DVB-H technology. As another example, Broadcast Transmission Network A may be based on MediaFLO technology, while Broadcast Transmission Network B 155 may be based on DVB-H technology.

The WTRU 110 may include two LLDs (LLD A 120 and LLD B 122), a mobility management function 118, a broadcast management function 116, and a media application 112. LLD A 120 may transmit and/or receive wireless data (including broadcast service data from the broadcast system 140) via an air interface with Base Station A 146. The media application 112 may display broadcast service data from the broadcast system 140 on a display (not depicted) of the WTRU 110. LLD B 122 may transmit and/or receive wireless data (including broadcast service data from the broadcast system 140) via an air interface with Base Station B 156. Media Application B 114 may display broadcast service data from Transmission Network B 155 on the display of the WTRU 110. The media application 112 may be, for example, an OMA BCAST client application, Mobile TV application, and/or other types of application for the display of broadcast service data.

The mobility management function 118 in the WTRU 110 may perform functionality related to handover of the WTRU 110 between the two broadcast transmission networks 145, 155. The mobility management function 118 may, for example, receive, generate, and/or store information relating to radio access networks with which the LLDs in the WTRU (such as LLD A 120 and LLD B 122) may communicate. The mobility management function 118 may also receive Quality of Service (QoS) information provided by the LLDs 120, 122, and the QoS information may be used by the WTRU 110 for making handover decisions. Alternatively or additionally, the mobility management function 118 may provide commands to the LLDs 120, 122 to perform handover and/or turn on or off. The mobility management function 118 may be based on technology such as Institute of Electrical and Electronics Engineers (IEEE) 802.21, 802.21a, 802.21b, 802.21c, and/or any other 802.21x technology. The mobility management function 118 may be or include an MIH Function, and perform the functionality described in IEEE 802.21 and/or 802.21b as performed by the MIH Function.

The mobility management server 138 may also perform functionality related to handover of the WTRU 110 between the broadcast transmission networks 145, 155. The mobility management server 138 may, for example, receive measurement data from the mobility management function 118 at the WTRU 110, communicate with other mobility management servers (not depicted) or network elements (not depicted) for the provisioning of radio-level network resources required for handover, communicate with the WTRU 110 regarding handover. As described above, the mobility management function 118 in the WTRU 110 may be or include an MIH Function and/or perform MIH-related functionality. In such an instance, the mobility management server 138 may be an MIH server, and/or perform MIH functionality described in IEEE 802.21 and/or 802.21b as being performed by a remote MIH Function.

In an instance where the mobility management function 118 performs MIH functionality, the mobility management function 118 may receive media-specific primitives from the LLDs 120, 122 that indicate, for example, that a new link has been detected, that a link has gone up, that a link has gone down, that one or more link parameters have passed a threshold, that a link failure is imminent, that a handover is imminent, that a handover is complete, and/or that a Protocol Data Unit (PDU) has been transmitted. The mobility management function 118 may then generate a corresponding MIH message, such as MIH_Link Detected, MIH_Link_Up, MIH_Link_Down, MIH_Link_Parameters_Report, MIH_Link_Going_Down, MIH_Link_Handover_Imminent, MIH_Link_Handover_Complete, or MIH_Link_PDU_Transmit_Status messages. The mobility management function 118 may then transmit the generated MIH message to the mobility management server 138. The mobility management function 118 may also receive MIH commands from the mobility management server 138, such as MIH Link Get Parameters, MIH_Link_Configure_Thresholds, MIH Link_Actions, MIH_Net_HO_Commit, or MIH_Net_Bcst_HO_Commit messages. The mobility management function 118, in response to an MIH command, may communicate with one or more of the LLDs 120, 122 to perform the requested action. For example, an MIH_Net_HO_Commit or MIH Net_Bcst_HO_Commit command may indicate that a handover should be performed; in response to an MIH_Net_HO_Commit or MIH Net_Bcst_HO_Commit command, the mobility management function 118 send media-specific primitives to the LLDs 120, 122 to execute the command.

The broadcast management function 116, the mobility management function 118, the broadcast management server 136, and/or the mobility management server 138 may coordinate to perform a handover of a broadcast service between the broadcast transmission networks 145, 155. For example, the mobility management function 118 may notify the broadcast management function 116 when a handover between broadcast transmission networks 145, 155 is being performed. Alternatively or additionally, the mobility management function 118 in the WTRU 110 may make a determination regarding whether the handover between broadcast transmission networks 145, 155 should be performed. In such an instance, the broadcast management function 116 may communicate information to the mobility management function 118 regarding whether the broadcast service is available in the target broadcast network 145, 155 or not; the mobility management function 118 may use this information to determine whether the handover should be performed. Further, when a handover is being performed, the broadcast management function 116 at the WTRU 110 may transmit information to the broadcast management server 136 that indicates that the handover is being performed. The broadcast management server 136 may then communicate with the components 141, 142, 145, 146, 155, 156 in the broadcast system 140 to establish the service in the target broadcast network 145, 155.

The broadcast management server 136 and/or the mobility management server 138 may be included as part of the broadcast service network 141, in a core network (not depicted) or radio access network (not depicted) in Broadcast Transmission Network A 145, or in a core network (not depicted) or radio access network (not depicted) in Broadcast Transmission Network B 155. Alternatively or additionally, the broadcast management server 136 and/or the mobility management server 138 may be connected to other elements 140, 141, 142, 144, 145, 146, 155, 156 shown in FIG. 1 via the Internet and/or other private or public networks. Further, the broadcast management server 136 and mobility management server 138 may be co-located at a single network node.

The architecture 100 of FIG. 1 may also include one or more interaction networks (not depicted), via which the WTRU may communicate data to the broadcast system 140. The broadcast transmission networks 145, 155 may both, as an example, use downlink-only radio access technologies such as MediaFLO or DVB-H. In such an instance, it is not possible for the WTRU 110 to communicate data to the broadcast system 140 via the broadcast transmission networks 145, 155. Via the interaction networks, the WTRU may communicate data such as the data described above as communicated by broadcast management function 116, the mobility management function 118. Alternatively or additionally, the media application 112 in the WTRU 110 may communicate control data to the service application function 144 and/or the service management function 142 related to receiving broadcast service data. The architecture 100 of FIG. 1 may include one or more interaction networks regardless of whether the broadcast transmission networks 145 use downlink-only radio access technologies or bi-directional radio access technologies.

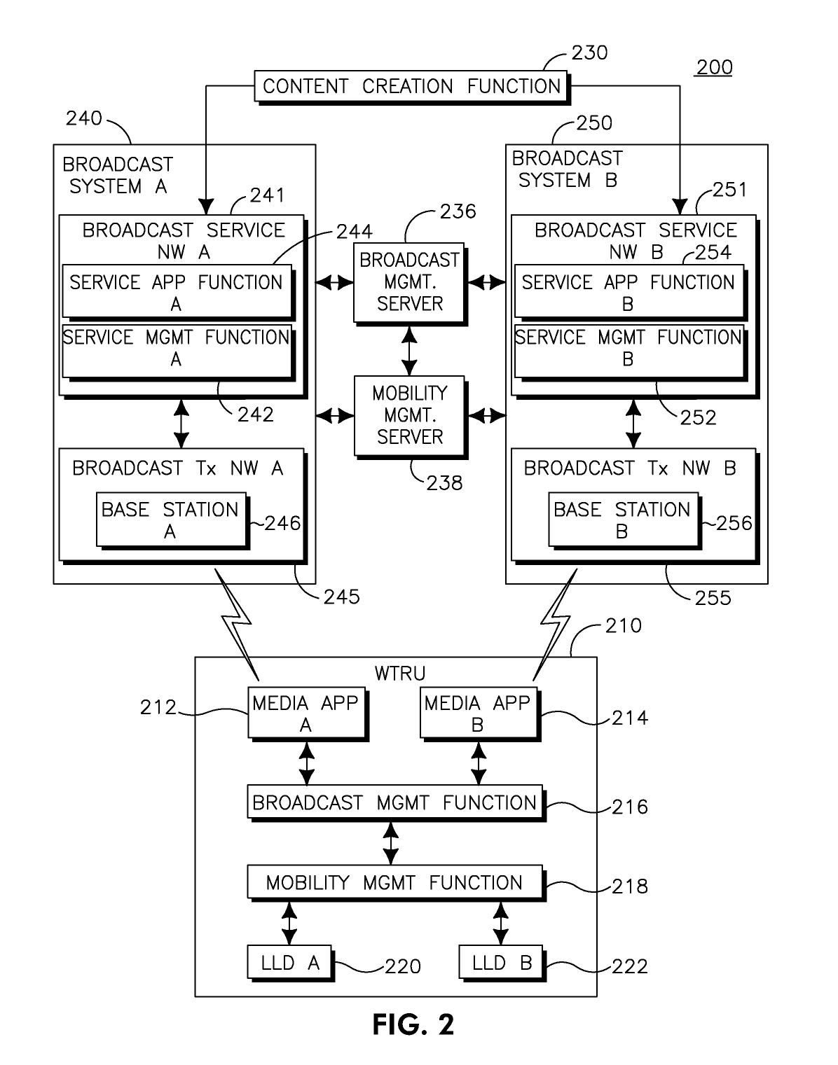

FIG. 2 shows an example architecture 200 for the handover of a broadcast service between two broadcast systems 240, 250. The architecture 200 includes a content creation function 230, a broadcast management server 236, a mobility management server 238, a wireless transmit/receive unit (WTRU) 210, and two broadcast systems (Broadcast System A 240 and Broadcast System B 250). As will be described in further detail below, the second example architecture 200 supports the handover of a broadcast service between the two broadcast systems 240, 250. As an example, Broadcast System A 240 may provide a broadcast service to the WTRU 210, and the broadcast service may be handed over from Broadcast System A 240 to Broadcast System B 250.

Broadcast System A 240 may includes Broadcast Service Network A 241, which may include Service Management Function A 242 and Service Application Function A 244. Broadcast System A 240 may also include Broadcast Transmission Network A 245, which may include Base Station A 246. Broadcast System A 240 may receive broadcast content data from the content creation function 230 and transmit broadcast service data to the WTRU 210 via Base Station A 246 in Broadcast Transmission Network A 245. Components 241, 242, 244, 245, 246 in Broadcast System A 240 may possess similar attributes and/or perform analogous functions to the analogous components 141, 142, 144, 145, 146, 155, 156 described above with reference to the broadcast system 140 of FIG. 1.

Broadcast System B 250 may include Broadcast Service Network B 251, which may include Service Management Function B 252 and Service Application Function B 254. Broadcast System B 250 may also include Broadcast Transmission Network B 255, which may include Base Station B 246. Broadcast System B 240 may receive broadcast content data from the content creation function 230 and transmit broadcast service data to the WTRU 210 via Base Station B 256 in Broadcast Transmission Network B 255. Components 251, 252, 254, 255, 226 in Broadcast System B 250 may possess similar attributes and/or perform analogous functions to the analogous components 141, 142, 144, 145, 146, 155, 156 described above with reference to the broadcast system 140 of FIG. 1.

Broadcast System A 240 and Broadcast System B 250 may be based on different technologies. As one example, Broadcast Service Network A 141 may be based on OMA BCAST technology and Broadcast Transmission Network A 145 may be based on GERAN/MBMS or UMTS/MBMS technology, while Broadcast Service Network B 151 may be based on DVB-H IPDC technology and Broadcast Transmission Network B 155 may be based on DVB-H technology.

The WTRU 210 may include two LLDs (LLD A 220 and LLD B 222), a mobility management function 218, a broadcast management function 216, and one or more media applications, such as Media Application A 212 and Media Application B 214. LLD A 220 may transmit and/or receive wireless data (including broadcast service data from the Broadcast System A 240) via an air interface with Base Station A 246. Media Application A 212 may display broadcast service data from Broadcast System A 240 on a display (not depicted) of the WTRU 210. LLD B 222 may transmit and/or receive wireless data (including broadcast service data from Broadcast System B 250) via an air interface with Base Station B 256. Media Application B 214 may display broadcast service data from Broadcast System B 250 on the display of the WTRU 210. Alternatively or additionally, the components 212, 214, 216, 218, 220, 222 may possess similar attributes and/or perform similar functions to the analogous components 112, 116, 118, 120, 122 described above with reference to the WTRU 110 of FIG. 1.

The broadcast management function 216, the mobility management function 218, the broadcast management server 236, and/or the mobility management server 238 may coordinate to perform a handover of a broadcast service between the broadcast systems 240, 250. For example, when a handover involves a change in radio access technology, the broadcast management function 216 may notify one or more of the media applications 212, 214 that the radio access technology has changed, and/or communicate information to one or more of the media applications 212, 214 that includes broadcast service configuration data for playing the broadcast service data in the new radio access technology. The broadcast management function 116 may also receive information from the mobility management function 118 such as which radio access technology is being used, which data rates are available using the radio access technology, and/or a QoS that is expected using the radio access technology. Alternatively or additionally, the broadcast management function 216, the mobility management function 218, the broadcast management server 236, and/or the mobility management server 238 may possess attributes and/or perform similar functions to the analogous components 116, 118, 136, 138 described above with reference to FIG. 1.

The architecture 200 of FIG. 2 may also include one or more interaction networks (not depicted), via which the WTRU may communicate data to the broadcast systems 240, 250. The broadcast transmission networks 245, 255 may both, as an example, use downlink-only radio access technologies such as MediaFLO or DVB-H. In such an instance, it is not possible for the WTRU 210 to communicate data to the broadcast system 240 via the broadcast transmission networks 245, 255. Via the interaction networks, the WTRU may communicate data such as the data described above as communicated by broadcast management function 216, the mobility management function 218. Alternatively or additionally, the media applications 212, 214 in the WTRU 210 may communicate control data to the service application functions 244, 254 and/or the service management functions 242, 252 related to receiving broadcast service data. The architecture 200 of FIG. 2 may include one or more interaction networks regardless of whether the broadcast transmission networks 245 use downlink-only radio access technologies or bi-directional radio access technologies.

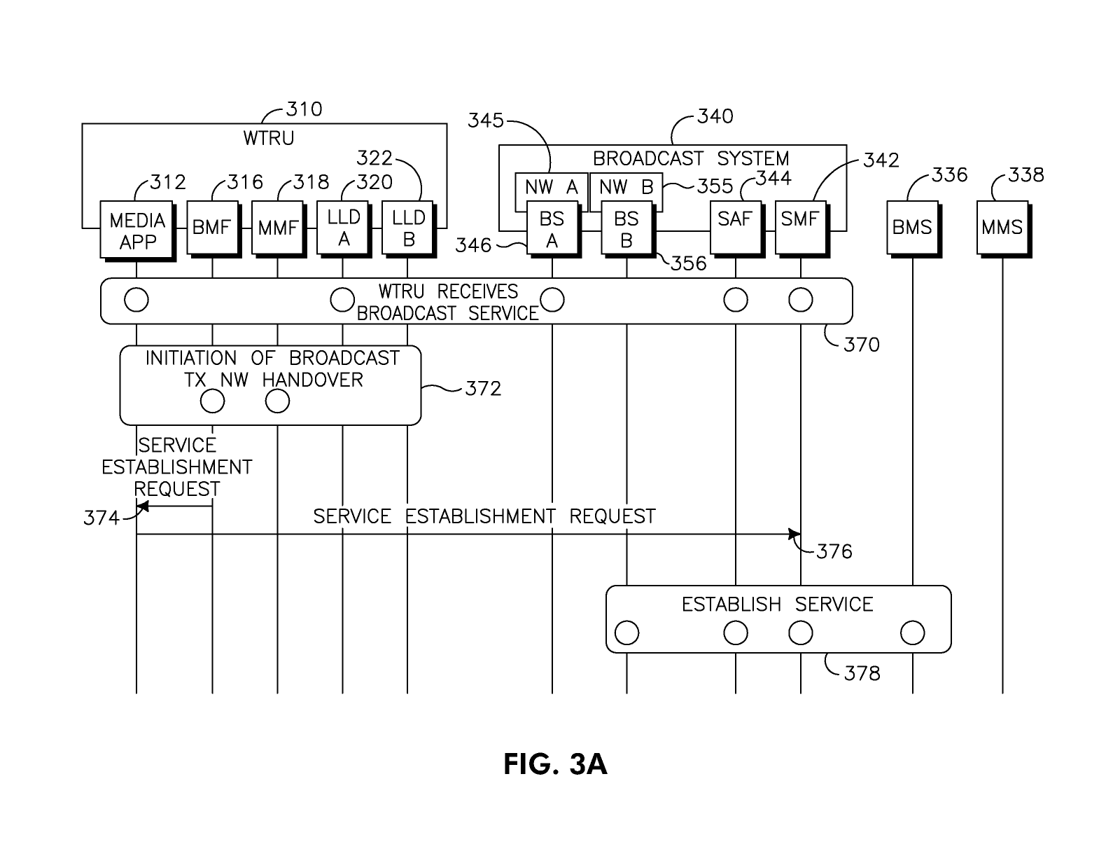

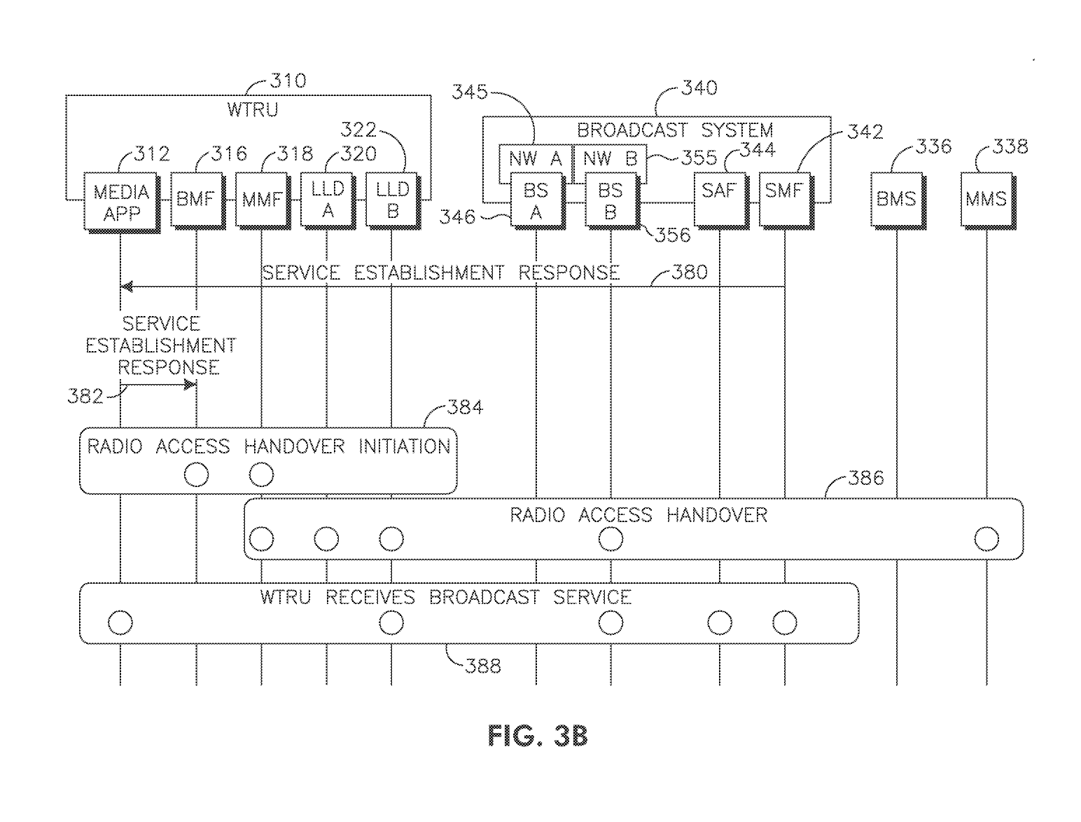

FIGS. 3A-3B show a method for the WTRU-initiated handover of a broadcast service between broadcast transmission networks. FIGS. 3A-3B show a WTRU 310 that includes a media application 312, a broadcast management function 316, a mobility management function 318, and two LLDs (LLD A 320 and LLD B 322). FIGS. 3A-3B also show a broadcast system 340 that includes a broadcast service network (not depicted) that includes a service application function A 344 and a service management function 342. The broadcast system 340 also includes two broadcast transmission networks, Broadcast Transmission Network A 345 and Broadcast Transmission Network B 355. Broadcast Transmission Network A 345 include Base Station A 346, and Broadcast Transmission Network B 355 may include Base Station B 356. The two broadcast transmission networks 345, 355 may be based on different technologies; as one example, Broadcast Transmission Network A 345 may be based on UMTS/MBMS technology, while Broadcast Transmission Network B 355 may be based on DVB-H technology. LLD A 320 in the WTRU 310 may be capable of communicating with Base Station A 346, while LLD B 322 may be capable of communicating with Base Station B 356.

The method of FIGS. 3A-3B may begin as shown in FIG. 3A with the WTRU 310 receiving a broadcast service from the broadcast system 340 via Base Station A 346 (step 370). The broadcast system 340 may receive broadcast service data from a content creation function (not depicted), and communicate the broadcast service data to the WTRU 310 via a radio link between Base Station A 346 and LLD A 320. The media application 312 may display the received broadcast service data in a display (not depicted) 310 that is a part of or is connected to the WTRU 310.

A handover from the broadcast service from the Broadcast Transmission Network A 345 to Broadcast Transmission Network B 355 may then be initiated by the WTRU (step 372). This may include a number of actions performed by the mobility management function 318, broadcast management function 316, and/or broadcast management server 336. The mobility management function 318 may determine, for example, that a handover should be performed from Transmission Network A 345 to Broadcast Transmission Network B 355 based on QoS information, measurement information, and/or other information obtained from LLD A 320 and/or LLD B 322. The mobility management function 318 may then request information from the broadcast management function 316 that indicates whether the broadcast service can be established in Broadcast Transmission Network B 355, and/or whether the broadcast service is already established in Broadcast Transmission Network B 355. This broadcast management function 316 may store the information that is responsive to this request locally at the WTRU 310 in one or more computer-readable storage media, and/or the broadcast management function 316 may obtain the information from the broadcast management server 336. The broadcast management function 316 may then communicate the responsive information to the mobility management function 318. If the broadcast service cannot be established in the target broadcast transmission network, the mobility management function 318 may determine that the handover should not be performed. However, if the service can be established in the target broadcast transmission network but is not already established, the mobility management function 318 may determine that the service should be established in the target broadcast transmission network. If the mobility management function 318 determines that service establishment should be performed, the mobility management function 318 may communicate to the broadcast management function 316 that the service establishment should be performed.

The broadcast management function 316 may then communicate a service establishment request message to the media application 312 (step 374). This message may indicate a request for establishment of the broadcast service in the Broadcast Transmission Network B 355.

In response to the service establishment request message, the media application 312 may transmit a service establishment request message to the service management function 342 (step 376). This service establishment request message may be defined according to a technology upon which the service management function 342 is based. For example, if the service management function 342 is based on OMA BCAST technology, this service establishment request message may be an OMA BCAST message. The service establishment request message may indicate a request, for example, for the Broadcast System 340 to establish the service in Broadcast Transmission Network B 355.

In response to the service establishment request message, the service management function 342 may initiate the establishment of the broadcast service in Broadcast Transmission Network B 355 (step 378). Base Station B 356, the service application function 352, and/or other elements in Broadcast Transmission Network B 355 (not depicted) may also participate in the establishment of the service. This may include, for example, the communication of service configuration data from the broadcast management server 336 to Service Application Function B 352, related to the establishment of the service in Broadcast Service Network B 351.

Referring to FIG. 3B, the service management function 342 may then transmit a service establishment response message to the media application 312 at the WTRU (step 380). In response to the service establishment response message received from the service management function 342, the media application 312 may communicate a service establishment response message to the broadcast management function 316 (step 382). In response to the service establishment response message, the broadcast management function 316 and/or the mobility management function 318 may initiate a radio access handover (step 384). This may include, for example, the broadcast management function 316 communicating the service establishment response message to the mobility management function 318. The mobility management function 318 may make a determination, based on the service establishment response message, that a radio access handover should be performed.

The WTRU 310, mobility management server 338, Base Station A 346 (and/or other elements in Broadcast Transmission Network A 345), and/or Base Station B 356 (and/or other elements in Broadcast Transmission Network B 355) may perform a radio access handover procedure (step 386). The procedure may be performed, for example, using any procedure for handover described in IEEE 802.21 and/or 802.21b, or any other appropriate handover procedure. During the radio access handover, LLD B 322 may establish a radio link to Base Station B 356 (if it does not already have a link established), and/or LLD A 320 may terminate its radio link to Base Station A 346. LLD B 322 may power on (if it was not already powered on) and establish layer one and layer two communications (as well as high-layer communications, if appropriate) with Base Station B 356. LLD A 320 may power off or power down, and/or terminate layer one and/or layer two communications with Base Station A 346, and/or take other actions (e.g., entering an idle mode) consistent with the handover of radio access to LLD B 322.

After the radio access handover procedure has been performed, the WTRU 310 may receive the broadcast service from Broadcast Transmission Network B 355 (step 378). The broadcast system 340 may receive broadcast service data from the content creation function (not depicted), and communicate the broadcast service data to the WTRU 310 via the radio link between Base Station B 356 and LLD B 320. The media application 312 may display the received broadcast service data in the display (not depicted) 310 that is a part of or is connected to the WTRU 310.

Although FIGS. 3A-3B show a single media application 312 in the WTRU 310, the method of FIGS. 3A-3B may also be performed, mutatis mutandis, using more than one media application. As an example, a first media application may display broadcast service data received from Broadcast Transmission Network A 345, as performed by the media application 312 in step 370, while a second media application may display broadcast service data received from Broadcast Transmission Network B 355, as performed by the media application 312 in step 388.

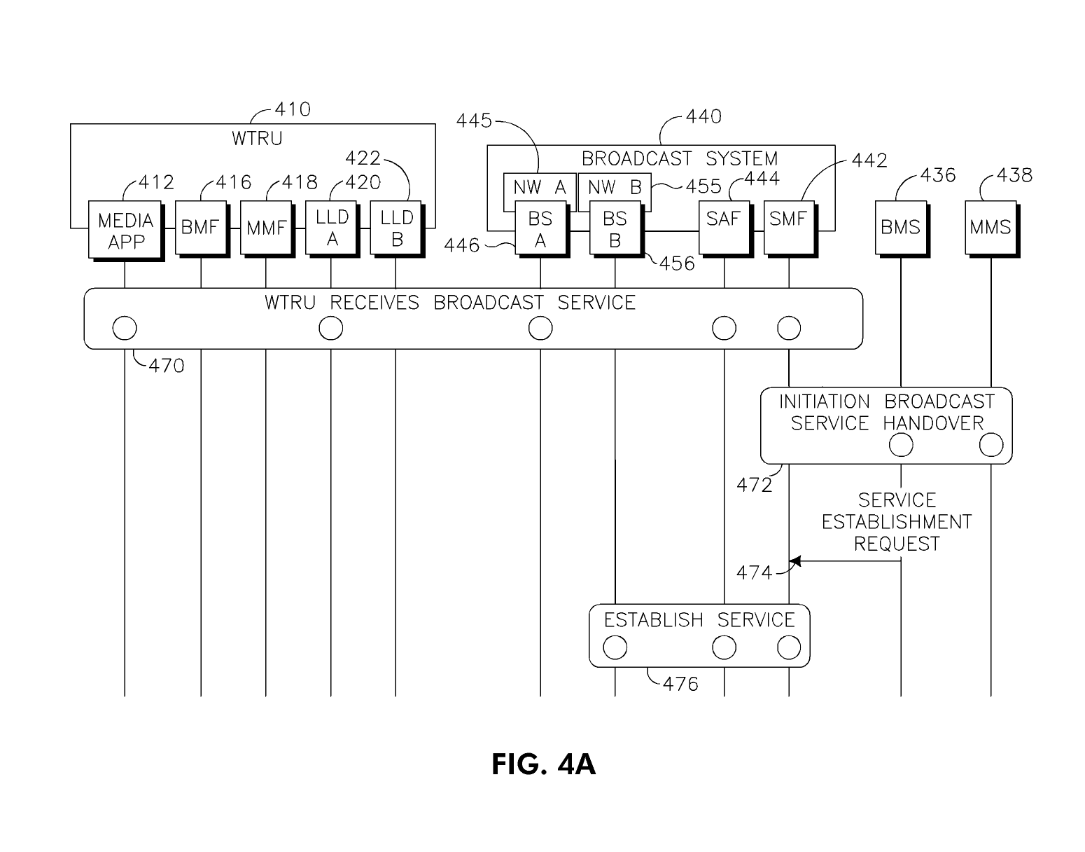

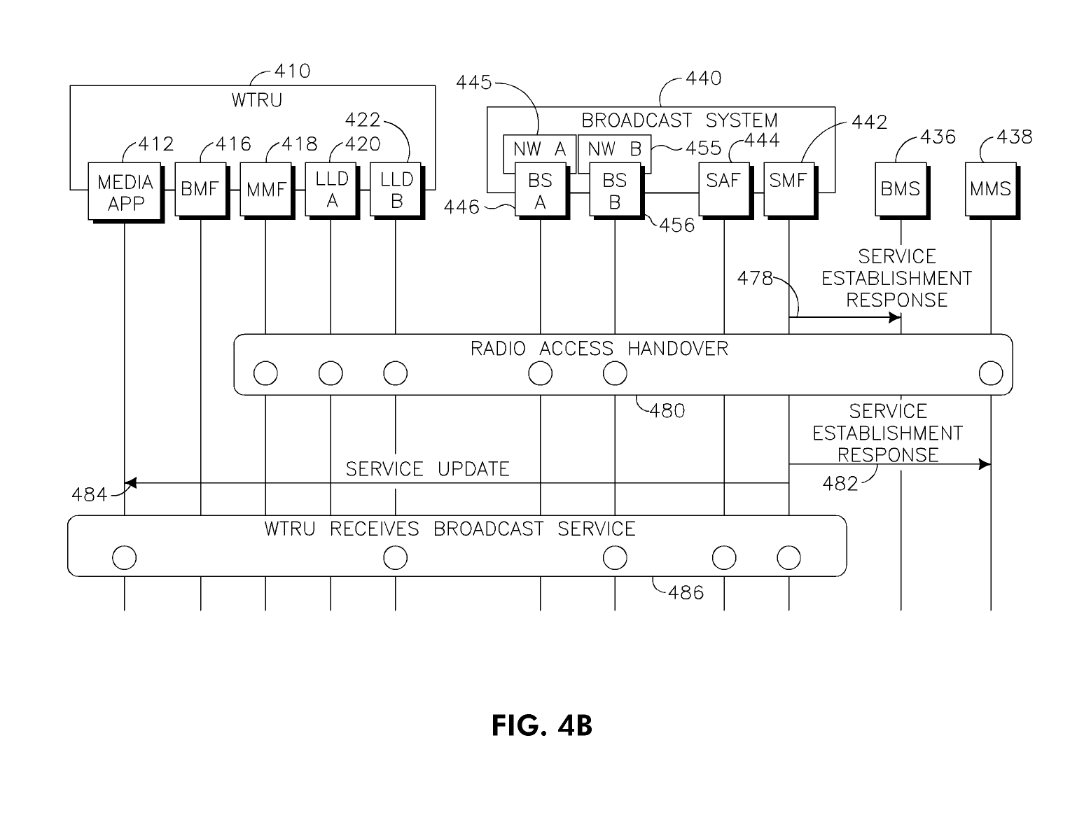

FIGS. 4A-4B show a method for the network-initiated handover of a broadcast service between two broadcast transmission networks 445, 455. FIGS. 4A-4B show a WTRU 410 that includes a media application 412, a broadcast management function 416, a mobility management function 418, and two LLDs (LLD A 420 and LLD B 422). FIGS. 4A-4B also shows a broadcast system 440 that includes a broadcast service network (not depicted) that includes a service application function 444 and a service management function 442. The broadcast system 440 also includes two broadcast transmission networks, Broadcast Transmission Network A 445 and Broadcast Transmission Network B 455. Broadcast Transmission Network A 445 include Base Station A 446, and Broadcast Transmission Network B 455 may include Base Station B 456. The two broadcast transmission networks 445, 455 may be based on different technologies; as one example, Broadcast Transmission Network A 445 may be based on DVB-H technology, while Broadcast Transmission Network B 455 may be based on MediaFLO technology. LLD A 420 in the WTRU may be capable of communicating with Base Station A 446, while LLD B 422 may be capable of communicating with Base Station B 456.

The method of FIGS. 4A-4B may begin as shown in FIG. 4A with the WTRU 410 receiving a broadcast service from the broadcast system 440 via Base Station A 446 (step 470). The broadcast system 440 may receive broadcast service data from a content creation function (not depicted), and communicate the broadcast service data to the WTRU 410 via a radio link between Base Station A 446 and LLD A 420. The media application 412 may display the received broadcast service data in a display (not depicted) that is a part of, or is connected to, the WTRU 410.

The handover of the broadcast service may then be initiated (step 472). This may include, for example, the broadcast management server 436 and/or the mobility management server 438 making a determination that the broadcast service should be handed over from Broadcast Transmission Network A 445 to Broadcast Transmission Network B 455. This determination may be based on, for example, whether the broadcast service is currently available in Broadcast Transmission Network B 455, whether Broadcast Transmission Network B 455 supports the service, and/or other parameters related to establishment of the service. If Broadcast Transmission Network B 455 supports the service but the service is not currently established in Broadcast Transmission Network B 455, the broadcast management server 436 may determine that the broadcast service should be established in Broadcast Transmission Network B 455.

The broadcast management server 436 may then communicate a service establishment request message to the service management function 442 (step 474). Alternatively or additionally, this message may be sent by the mobility management server 438 to the service management function 442. This message may indicate a request for establishment of the broadcast service in Broadcast Transmission Network B 455. This service establishment request message may include one or more parameters that indicate the type of the service to be handed over to Broadcast Transmission Network B 455, and/or other information that describes the service. Alternatively or additionally, the service management request message may include broadcast service configuration data and/or other data related to the service. As one example, the service establishment request message may include a channel tuning parameter that describes the channel being broadcast in the service.

In response to the service establishment request message, the service application function 444, the service management function 442, and elements in Broadcast Transmission Network B 455 (including Base Station B 456) may establish the service in Broadcast Transmission Network B 455 (step 476).

Referring to FIG. 4B, the service management function 442 may transmit a service establishment response message to the broadcast management server 436 (step 478). This service establishment response message may indicate, for example, that establishment of the service in Broadcast Transmission Network B 455 has been completed. The broadcast management server 436 may then communicate with the mobility management server 438 to notify the mobility management server 438 that the establishment of the service in Broadcast Transmission Network B 455 has been completed.

The WTRU 410, mobility management server 438, Base Station A 446, and/or Base Station B 456 (and/or other components (not depicted) from Broadcast Transmission Network A 445 and/or Broadcast Transmission Network B 455) may then perform a radio access handover procedure (step 480) from Broadcast Transmission Network A 445 to Broadcast Transmission Network B 455. The procedure may be performed, for example, using any procedure for handover described in IEEE 802.21 and/or 802.21b, or any other appropriate handover procedure. During the radio access handover, LLD B 422 may establish a radio link to Base Station B 456 (if it does not already have a link established), and/or LLD A 420 may terminate its radio link to Base Station A 446. LLD B 422 may power on (if it was not already powered on) and establish layer one and layer two communications (as well as high-layer communications, if appropriate) with Base Station B 456. LLD A 420 may power off or power down, and/or terminate layer one and/or layer two communications with Base Station A 446, and/or take other actions (e.g., entering an idle mode) consistent with the handover to LLD B 422.

The service management function 442 may send a service establishment response message to the mobility management server 438. This service establishment response message may indicate, for example, that the radio access handover has been completed, and/or that the establishment of the service in Broadcast Transmission Network B 455 has been completed.

The service management function 442 may send a service update message to the media application 412 at the WTRU 410 (step 484). The service update message may include, for example, broadcast service configuration data that the media application 412 may use to receive the broadcast service via Broadcast Transmission Network B 455. Based on the service update message, the media application 412 may update its operational parameters and/or otherwise reconfigure in order to receive and play the broadcast service data from via Broadcast Transmission Network B 455.

The WTRU 410 may then receive the broadcast service from via Broadcast Transmission Network B 455 (step 486). Broadcast Service Network B 441 may receive broadcast service data from the content creation function (not depicted), and communicate the broadcast service data to the WTRU 410 via the radio link between Base Station B 456 and LLD B 422. The media application 412 may display the received broadcast service data in the display (not depicted) that is a part of or is connected to the WTRU 410.

Although FIGS. 4A-4B show a single media application 412 in the WTRU 410, the method of FIGS. 4A-4B may also be performed, mutatis mutandis, using more than one media application. As an example, a first media application may display broadcast service data received from Broadcast Transmission Network A 445, as performed by the media application 412 in step 470, while a second media application may display broadcast service data received from Broadcast Transmission Network B 455, as performed by the media application 412 in step 486.

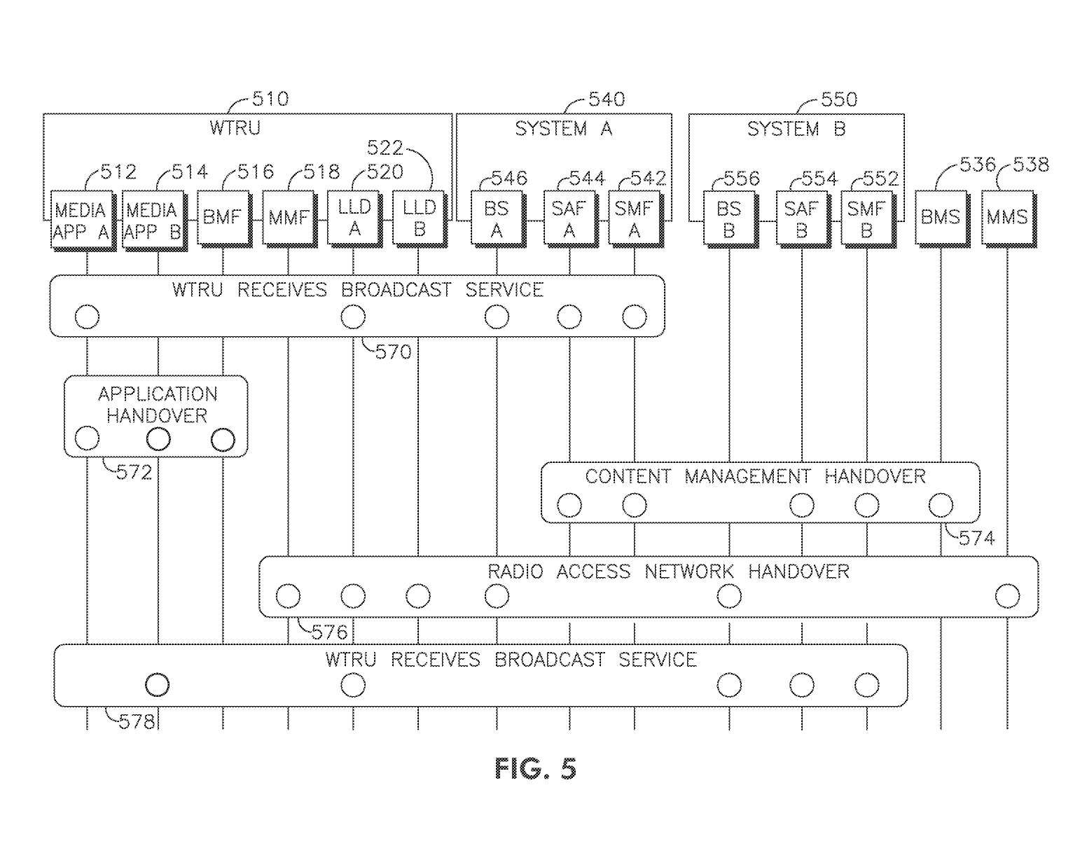

FIG. 5 shows a method for the handover of a broadcast service between two broadcast systems. FIG. 5 shows a WTRU 510 and two broadcast systems, Broadcast System A 540 and Broadcast System B 550. The WTRU 510 includes two media applications (Media Application A 212 and Media Application B 214), a broadcast management function 516, a mobility management function 518, and two LLDs (LLD A 520 and LLD B 522). Broadcast System A 540 includes a broadcast service network (not depicted) that includes Service Application Function A 544 and Service Management Function A 542. Broadcast System A 540 may also include a broadcast transmission network (not depicted) that includes Base Station A 546. Broadcast System B 550 includes a broadcast service network (not depicted) that includes Service Application Function B 554 and Service Management Function B 552. Broadcast System B 550 may also include a broadcast transmission network (not depicted) that includes Base Station B 556. Media Application A 512 at the WTRU 510 may display broadcast service data from Broadcast System A 540 on a display (not depicted) of the WTRU 510, while Media Application B 514 may display broadcast service data from Broadcast System B 550 on the display of the WTRU 510.

The method of FIG. 5 may begin with the WTRU 510 receiving a broadcast service Broadcast System A 540 via Base Station A 546 (step 570). Broadcast System A 540 may receive broadcast service data from a content creation function (not depicted), and communicate the broadcast service data to the WTRU 510 via a radio link between Base Station A 546 and LLD A 520. Media Application A 512 may display the received broadcast service data in a display (not depicted) that is a part of or is connected to the WTRU 510.

Media Application A 512, Media Application B 514, and/or the broadcast management function 516 at the WTRU 510 may perform an application handover (step 572). This may include the broadcast management function 516 notifying Media Application A 512 and/or Media Application B 514 that a handover is being performed. This may also include the transfer of user context data from Media Application A 512 to Media Application B 514, so that the broadcast service may continued in Media Application B 514. The user context data may include, for example, information identifying the contents of broadcast service being displayed by Media Application A 512, bookmarks set by a user of the WTRU 510, whether subtitles are required and, if so, which language subtitles should be displayed in, and/or other user context data. This may also include Media Application B 514 initializing and/or adjusting operational parameters, to be able to receive the broadcast service from Broadcast System B 550. This may also include the broadcast management function 516 communicating broadcast service configuration data to Media Application B 514, such that Media Application B 514 may use the broadcast service configuration data to display the broadcast service data.

The broadcast management server 536, Service Application Function A 544, Service Management Function A 542, Service Application Function B 554, and/or Service Management Function B 552 may perform a content management handover procedure (step 574). Here, the broadcast management server 536 may transmit and/or receive one or more messages to/from Service Application Function A 544 and/or Service Management Function A 542. This may also include the broadcast management server 536 transmitting and/or receiving one or more messages to/from Service Application Function B 554, and/or Service Management Function B 552 The messages sent to Service Application Function B 554, and/or Service Management Function B 552 by the broadcast management server 536 may indicate, for example, the new RAT that will be used (i.e., the RAT used between LLD B 522 and Base Station B 556) for providing the broadcast service to the WTRU 510. Alternatively or additionally, the messages may indicate broadcast service configuration data related to providing the broadcast service in the new RAT. The Service Application Function B 554 and/or Service Management Function B 552 may (if necessary) change operational parameters to ensure that the broadcast service is encoded in accordance with the new RAT that will be used.

The WTRU 510, mobility management server 538, Base Station A 546, and/or Base Station B 556 may perform a radio access handover procedure (step 576). Other entities (not depicted) in the broadcast transmission network of which Base Station A 546 is a part and/or in the broadcast transmission network of which Base Station B 556 is a part may also participate in this radio access handover procedure. The procedure may be performed, for example, using any procedure for handover described in IEEE 802.21 and/or 802.21b, or any other appropriate handover procedure. Alternatively or additionally, the handover procedure may be performed using technologies such as Session Initiation Protocol (SIP), Mobile IP, and/or Proxy MobileIP (PMIP). This may include, for example, the mobility management server 538 communicating with one or more network elements (not depicted) that handle SIP, MIP, and/or PMIP functionality to trigger SIP and/or MIP aspects of the handover procedure. During the radio access handover, LLD B 522 may establish a radio link to Base Station B 556 (if it does not already have a link established), and/or LLD A 520 may terminate its radio link to Base Station A 546. LLD B 522 may power on (if it was not already powered on) and establish layer one and layer two communications (as well as high-layer communications, if appropriate) with Base Station B 556. LLD A 520 may power off or power down, and/or terminate layer one and/or layer two communications with Base Station A 546, and/or take other actions (e.g., entering an idle mode) consistent with the handover of radio access to LLD B 522. The radio access handover procedure may also include the mobility management server 538 notifying the broadcast management server 536 that the radio access handover is being performed.

After the radio access handover procedures and service-/application-level handover procedures have been performed, the WTRU 510 may receive the broadcast service from Broadcast System B 550 (step 578). Broadcast System B 550 may receive broadcast service data from the content creation function (not depicted), and communicate the broadcast service data to the WTRU 510 via the radio link between Base Station B 556 and LLD B 520. Media Application B 512 may display the received broadcast service data in the display (not depicted) 510 that is a part of or is connected to the WTRU 510.

Although FIG. 5 shows that the WTRU 510 includes two media applications 512, 514, the method of FIG. 5 may also be performed, mutatis mutandis, with a single media application. In such an instance, the single media application may be configured to display broadcast service data received from Broadcast System A 540, as performed by Media Application A 512 in step 570. During an application handover (as shown in step 572), the media application may be configured to display broadcast service data received from Broadcast System B 550. The media application may then display broadcast service data received from Broadcast System B 550, as performed by Media Application B 514 in step 578.

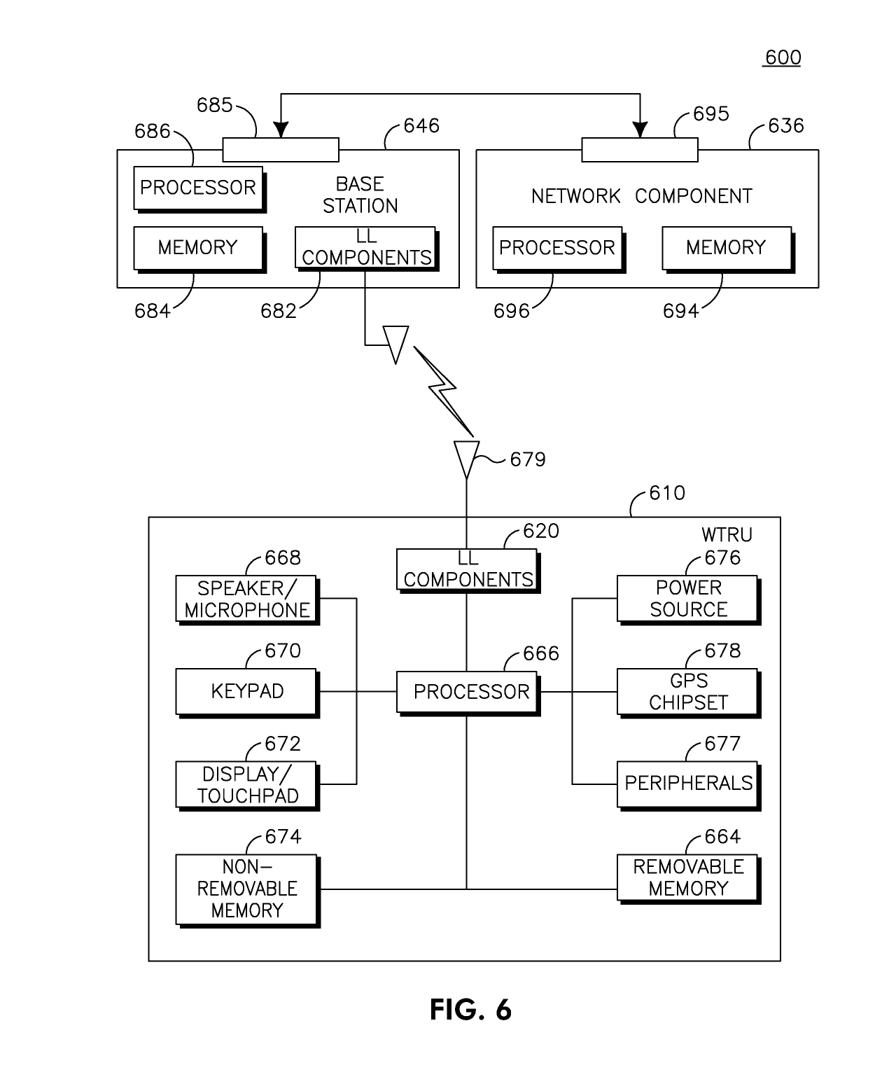

FIG. 6 is a diagram of an example communications system 600 in which the features described above with reference to FIGS. 1-5 may be implemented. The communications system 600 may be a multiple access system that provides content, such as voice, data, video, messaging, broadcast, etc., to multiple wireless users. The communications system 600 may enable multiple wireless users to access such content through the sharing of system resources, including wireless bandwidth. For example, the communications systems 600 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 6, the communications system 600 may include a WTRU 610, a base station 646, and a network component 636. The WTRU 610 may be any type of device configured to operate and/or communicate in a wireless environment. The base station 646 may be any type of device configured to wirelessly interface with the WTRU 610 to facilitate access to one or more communication networks, such as a core network (not depicted), the Internet (not depicted), and/or the network component 636. By way of example, the base station 646 may be a base transceiver station (BTS), a Node-B, an eNode B, a Home Node B, a Home eNode B, a site controller, an access point (AP), a wireless router, and the like. The network component 636 may be any component capable of communicate data to/from the WTRU via the base station 646, such as any one or any combination of network components 130, 136, 138, 142, 144, 230, 236, 238, 242, 244, 252, 254, 344, 342, 336, 338, 444, 442, 436, 438, 544, 542, 554, 552, 536, 538 described above with reference to FIGS. 1-5.

The base station 646 may be part of the RAN (not depicted), which may also include other base stations and/or network elements (not shown), such as a base station controller (BSC), a radio network controller (RNC), relay nodes, etc. The base station 646 may be configured to transmit and/or receive wireless signals within a particular geographic region, which may be referred to as a cell (not shown). The cell may further be divided into cell sectors. For example, the cell associated with the base station 646 may be divided into three sectors. Thus, in one embodiment, the base station 646 may include three lower layer components, i.e., one for each sector of the cell. In another embodiment, the base station 646 may employ multiple-input multiple output (MIMO) technology and, therefore, may utilize multiple lower layer components for each sector of the cell.

The base station 646 may communicate with the WTRU 610 over an air interface 647, which may be any suitable wireless communication link (e.g., radio frequency (RF), microwave, infrared (IR), ultraviolet (UV), visible light, etc.). The air interface 647 may be established using any suitable radio access technology (RAT). More specifically, as noted above, the communications system 600 may be a multiple access system and may employ one or more channel access schemes, such as CDMA, TDMA, FDMA, OFDMA, SC-FDMA, and the like. For example, the base station 646 and the WTRU 610 may implement a radio technology such as UTRAN, which may establish the air interface 647 using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 646 and the WTRU 610 may implement a radio technology such as Evolved UMTS Terrestrial Radio Access (E-UTRA), which may establish the air interface 647 using Long Term Evolution (LTE) and/or LTE-Advanced (LTE-A).

In other embodiments, the base station 646 and the WTRU 610 may implement radio technologies such as IEEE 802.16 (i.e., Worldwide Interoperability for Microwave Access (WiMAX)), CDMA2000, CDMA2000 6×, CDMA2000 EV-DO, Interim Standard 2000 (IS-2000), Interim Standard 95 (IS-95), Interim Standard 856 (IS-856), GSM, Enhanced Data rates for GSM Evolution (EDGE), GERAN, MBMS, MediaFLO, DVB-H, SHF, Advanced Television Systems Committee—Mobile/Handheld (ATSC-M/H), Digital Terrestrial Multimedia Broadcast (DTMB), and the like.

The base station 646 in FIG. 6 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 646 and the WTRU 610 may implement a radio technology such as IEEE 802.11 to establish a wireless local area network (WLAN). In another embodiment, the base station 646 and the WTRU 610 may implement a radio technology such as IEEE 802.15 to establish a wireless personal area network (WPAN). In yet another embodiment, the base station 646 and the WTRU 610 may utilize a cellular-based RAT (e.g., WCDMA, CDMA2000, GSM, LTE, LTE-A, etc.) to establish a picocell or femtocell. The base station 646 may have a direct connection to the Internet. In such an instance, the base station 646 may not be required to access the Internet via a core network (not depicted) to which the base station 646 is connected.

As described above, the base station 646 may be include in a RAN (not depicted), which may be in communication with a core network (not depicted). The core network may be any type of network configured to provide voice, data, applications, and/or voice over internet protocol (VoIP) services the WTRU 610. For example, the core network may provide call control, billing services, mobile location-based services, pre-paid calling, Internet connectivity, video distribution, etc., and/or perform high-level security functions, such as user authentication. Although not shown in FIG. 6, the RAN and/or the core network may be in direct or indirect communication with other RANs that employ the same RAT as the RAN or a different RAT. For example, in addition to being connected to a RAN which may be utilizing an E-UTRA radio technology, a core network may also be in communication with another RAN (not shown) employing a GSM radio technology.

A core network to which the base station 646 is connected may also serve as a gateway for the WTRU 610 to access a Public Switched Telephone Network (PTSN), the Internet, and/or other networks. The PSTN may include circuit-switched telephone networks that provide plain old telephone service (POTS). The Internet may include a global system of interconnected computer networks and devices that use common communication protocols, such as the transmission control protocol (TCP), user datagram protocol (UDP) and the internet protocol (IP) in the TCP/IP internet protocol suite. The other networks with which the WTRU may communicate via the core network may include wired or wireless communications networks owned and/or operated by other service providers. For example, the networks may include another core network connected to one or more RANs, which may employ the same RAT as the RAN of which the base station 646 is a part or a different RAT.

In addition to the components that may be found in a typical base station, the base station 646 may include a processor 686, a linked memory 672, one or more lower layer components 682, and one or more antennas 689. The one or more lower layer components 682 may be in communication with the processor 686 to facilitate the transmission of wireless data. The lower layer components 682 may transmit and/or receive wireless data via the one or more antennas 689. The base station 646 may additionally include a communications interface 685. The communications interface 685 may be configured to transmit and/or receive data from the network component 636. The base station 646 may be configured to perform any feature or combination of features attributed to any or any combination of base stations 146, 156, 246, 256, 346, 356, 446, 456, 546, 556 described above with reference to FIGS. 1-5.

As shown in FIG. 6, the network component 636 may include a processor 696 and a memory 694. The network component 636 may additionally include a communications interface 695. The communications interface 695 may be configured to transmit and/or receive data from the base station 684 via one or more wired or wireless networks, such as a core network, the Internet, and/or one or more other private or public network.

The network component may perform functionality described above with reference to FIGS. 1-5 as performed by any or any combination of service management functions 142, 242, 252, 342, 442, 542, 552, service application functions 144, 244, 254, 344, 444, 544, 554, broadcast management servers 136, 236, 336 436, 536 and/or mobility management servers 138, 238, 338, 438, 538. The processor 696 may be configured to generate and/or process messages and/or other data as described above with reference to any or any combination of the above-referenced network elements 136, 138, 144, 236, 238, 244, 254, 336, 338, 344, 436, 438, 444, 536, 538, 544, 554. In various embodiments, the functionality performed by one or more of the above-referenced network elements 136, 138, 144, 236, 238, 244, 254, 336, 338, 344, 436, 438, 444, 536, 538, 544, 554 may be described in one or more software modules stored in the memory 694 or other computer-readable storage media, and the one or more software modules may be executed by the processor 696.

Each or any of the communications interfaces 685, 695 may operate using wired or wireless communications technology, and/or may be or include a transceiver. Each or any of the communications interfaces 685, 695 may be capable of communicating using technologies such as, for example, Ethernet, Carrier Ethernet, fiber optics, microwave, xDSL (Digital Subscriber Line), Asynchronous Transfer Mode, (ATM), Signaling System 7 (SS7), IP, and/or IP/Multiprotocol Label Switching (MPLS).

As shown in FIG. 6, the WTRU 610 may include a processor 666, one or more lower layer components 620, one or more transmit/receive elements 679, a speaker/microphone 668, a keypad 670, a display/touchpad 672, non-removable memory 674, removable memory 664, a power source 676, a global positioning system (GPS) chipset 678, and other peripherals 677. The WTRU 610 may include any sub-combination of the foregoing elements while remaining consistent with an embodiment.

The processor 666 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 666 may perform signal coding, data processing, power control, input/output processing, and/or any other functionality that enables the WTRU 610 to operate in a wireless environment. The processor 666 may be coupled to the one or more lower layer components 620, which may be coupled to the one or more transmit/receive elements 679. While FIG. 6 depicts the processor 666 and lower layer components 620 as separate components, the processor 666 and one or more of the lower layer components 620 may be integrated together in an electronic package or chip.

The processor 666 of the WTRU 610 may be coupled to, and may receive user input data from, the speaker/microphone 668, the keypad 670, and/or the display/touchpad 672 (e.g., a liquid crystal display (LCD) display unit or organic light-emitting diode (OLED) display unit). The processor 666 may also output user data to the speaker/microphone 668, the keypad 670, and/or the display/touchpad 672. In addition, the processor 666 may access information from, and store data in, any type of suitable memory, such as the non-removable memory 674 and/or the removable memory 664. The non-removable memory 674 may include random-access memory (RAM), read-only memory (ROM), a hard disk, or any other type of memory storage device. The removable memory 632 may include a subscriber identity module (SIM) card, a memory stick, a secure digital (SD) memory card, and the like. In other embodiments, the processor 666 may access information from, and store data in, memory that is not physically located on the WTRU 610, such as on a server or a home computer (not shown).

The processor 666 may receive power from the power source 676, and may be configured to distribute and/or control the power to the other components in the WTRU 610. The power source 676 may be any suitable device for powering the WTRU 610. For example, the power source 676 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 666 may also be coupled to the GPS chipset 678, which may be configured to provide location information (e.g., longitude and latitude) regarding the current location of the WTRU 610. In addition to, or in lieu of, the information from the GPS chipset 678, the WTRU 610 may receive location information over the air interface 647 from a base station (e.g., base station 646 or another base station (not depicted)) and/or determine its location based on the timing of the signals being received from two or more nearby base stations. The WTRU 610 may acquire location information by way of any suitable location-determination method while remaining consistent with an embodiment.

The processor 666 may further be coupled to other peripherals 677, which may include one or more software and/or hardware modules that provide additional features, functionality and/or wired or wireless connectivity. For example, the peripherals 677 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

The one or more transmit/receive elements 679 may be configured to transmit signals to, and/or or receive signals from, a base station (e.g., the base station 646) over the air interface 647. For example, in one embodiment, the transmit/receive elements 679 may be or include an antenna configured to transmit and/or receive RF signals. In another embodiment, the transmit/receive elements 679 may be or include an emitter/detector configured to transmit and/or receive IR, UV, or visible light signals, for example. In yet another embodiment, the transmit/receive elements 679 may be configured to transmit and receive both RF and light signals. The transmit/receive elements 679 may be configured to transmit and/or receive any combination of wireless signals. Further, the WTRU 610 may employ Multiple Input and Multiple Output (MIMO) technology. Thus, in one embodiment, the WTRU 610 may include two or more transmit/receive elements 679 (e.g., multiple antennas) for transmitting and receiving wireless signals over the air interface 647.

The lower layer components 620 may be configured to modulate the signals that are to be transmitted by the transmit/receive element 622 and to demodulate the signals that are received by the transmit/receive element 622. As noted above, the WTRU 610 may have multi-mode capabilities. Thus, the lower layer components 620 may include multiple transceivers for enabling the WTRU 610 to communicate via multiple RATs, such as UTRAN, LTE, LTE-A, IEEE 802.11, DVB-H, or MediaFLO. Alternatively or additionally, the lower layer components 620 may include one or more multi-mode transceivers, wherein each multi-mode transceiver is capable of communicating via multiple RATs.

The processor 666 and/or the one or more lower layer components 620 may implement one or more protocol stacks for the reception of broadcast service data from the base station 646. In an instance, for example, where the WTRU 610 is capable of receiving broadcast service data using DVB-H, the processor 666 and/or one of the lower layer components 620 may implement protocols or technologies such as DVB-H Electronic Service Guide (ESG), OMA BCAST Digital Rights Management (DRM), File Delivery over Unidirectional Transport (FLUTE), Asynchronous Layered Coding (ALC)/ Layered Coding Transport (LCT), Hypertext Transport Protocol (HTTP), Multi-Protocol Encapsulation—Forward Error Correction (MPE-FEC), DVB Program Specific Information/Service Information (PSI/SI), Real Time Streaming Protocol (RTSP), Real-time Transport Protocol (RTP), and/or DVB-H layer one and layer two technologies. In an instance where the WTRU 610 is capable of receiving broadcast service data using MediaFLO, the processor 666 and/or one of the lower layer components 620 may implement protocols or technologies such as the Multicast Device Network Interface (MDNI) service layer, the MediaFLO Forward Link Only (FLO) transport layer, MediaFLO layer one or layer two technologies, and/or MediaFLO control plane functionality. In an instance where the WTRU 610 is capable of receiving broadcast service data using MBMS, the processor and/or one of the lower layer components 620 may implement protocols or technologies such as RTP, Real-Time Transport Control Protocol (RTCP), MBMS Forward Error Correction (FEC), and/or FLUTE.

The processor 666 and/or the one or more lower layer components 620 may also be configured to perform functionality described above with reference to any or any combination of broadcast management functions 116, 216, 316, 416, 516 and/or mobility management functions 118, 218, 318, 418, 518 described above with reference to FIGS. 1-5. In various embodiments, the functionality performed any or any combination of broadcast management functions 116, 216, 316, 416, 516 and/or mobility management functions 118, 218, 318, 418, 518 may be described in one or more software modules stored in the non-removable memory 674, removable memory 664, and/or other any other computer-readable storage medium, and may be executed by the processor 666. Alternatively or additionally, the WTRU 610 may include one or more specific-purpose processors (not depicted) or processor elements (not depicted) that may be configured to perform the functionality described above with reference to any or any combination of broadcast management functions 116, 216, 316, 416, 516 and/or mobility management functions 118, 218, 318, 418, 518.

The processor 666 may also execute one or more media applications (not depicted) that display graphical and/or audio broadcast service data. The media applications may perform functions such as but not limited to encoding, decoding, and/or displaying broadcast service data received by the one or more lower layer components 620. Alternatively or additionally, the one or more media applications may perform the functionality of any or any combination of the media applications 112, 212, 214, 312, 412, 512, 514 described above with reference to FIGS. 1-5. In various embodiments, the functionality performed by one or more of the media applications 112, 212, 214, 312, 412, 512, 514 may be described in one or more software modules stored in the non-removable memory 674, removable memory 664, and/or other any other computer-readable storage medium, and may be executed by the processor 666.

Each or any of the messages described in FIGS. 1-6 as being communicated between a broadcast management function 116, 216, 316, 416, 516 and a mobility management function 118, 218, 318, 418, 518 may be communicated in a number of different ways. For example, a broadcast management function 116, 216, 316, 416, 516 and a mobility management function 118, 218, 318, 418, 518 in the same may be performed using messages defined according to IEEE 802.21 and/or 802.21b, or according to any other appropriate protocol. Alternatively or additionally, in an instance where a broadcast management function 116, 216, 316, 416, 516 and a mobility management function 118, 218, 318, 418, 518 are implemented as software modules or sub-modules, the exchanges between the modules or sub-modules may be performed via an Application Programming Interface (API) or other appropriate interface. Alternatively or additionally, each or any of the messages described in FIGS. 1-6 as being communicated by or to a broadcast management function 116, 216, 316, 416, 516 may be defined according to IEEE 802.21 and/or 802.21b, or according to any other appropriate protocol. Similarly, each or any of the messages described in FIGS. 1-6 as being communicated by or to a broadcast management server 136, 236, 336, 436, 536 may be defined according to IEEE 802.21 and/or 802.21b, or according to any other appropriate protocol.

Although examples are provided above with reference to FIGS. 1-6 in terms of broadcast service data, the above-described principles are equally applicable, mutatis mutandis, to any other type of data that may be communicated using broadcast, multicast, unicast, downlink-only, bi-directional, and/or other data communication technology.

Although features and elements are described above in particular combinations, each feature or element can be used alone or in any combination with the other features and elements. For example, each feature or element as described above with reference to FIGS. 1-6 may be used alone without the other features and elements or in various combinations with or without other features and elements. Sub-elements of the methods and features described above with reference to FIGS. 1-6 may be performed in any arbitrary order (including concurrently), in any combination or sub-combination. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for use in a wireless transmit/receive unit (WTRU), the method comprising:
receiving a broadcast service via a first broadcast transmission network in a broadcast system;
determining whether the broadcast service is established in a second broadcast transmission network in the broadcast system, wherein the second broadcast transmission network is based on a different radio access technology from the first broadcast transmission network;
in response to a determination that the broadcast service is not established in the second broadcast transmission network, initiating establishment of the broadcast service in the second broadcast transmission network;
performing a handover to the second broadcast transmission network; and
receiving the broadcast service via the second broadcast transmission network.

2. The method of claim 1, wherein the initiating the establishment of the broadcast service in the second broadcast transmission network includes:
sending a service establishment request message to a service management function in the broadcast system.

3. The method of claim 2, further comprising:
receiving a service establishment response message from the service management function, indicating that the broadcast service has been established in the second broadcast transmission network;
wherein the performing the handover to the broadcast transmission network is performed in response to the service establishment response message.

4. The method of claim 1 wherein the handover to the second broadcast transmission network is performed using Institute of Electrical and Electronics Engineers (IEEE) Media Independent Handover (MIH) technology.

5. The method of claim 1 wherein the first broadcast transmission network or the second broadcast transmission network is based on Digital Video Broadcasting-Handheld (DVB-H) technology, MediaFLO technology, or Multimedia Broadcast Multicast Service (MBMS) technology, and wherein the second broadcast transmission network is based on DVB-H technology, MediaFLO technology, or MBMS technology.

6. A wireless transmit/receive unit (WTRU) comprising:
at least one lower layer component configured to receive a broadcast service via a first broadcast transmission network in a broadcast system;
a media application configured to play data associated with the broadcast service that is received via the first broadcast transmission network;
a broadcast management function configured to send a message to the media application to initiate establishment of the broadcast service in a second broadcast transmission network in the broadcast system;
wherein the media application is further configured to send a service establishment request message to a service management function in the broadcast system in response to the message from the broadcast management function, wherein the service establishment request message indicates a request for establishment of the broadcast service in the second broadcast transmission network;
wherein the at least one lower layer component is further configured to perform a handover to the second broadcast transmission network; and
wherein the media application is further configured to play data associated with the broadcast service that is received via the second broadcast transmission network.

7. The WTRU of claim 6, wherein the media application is further configured to receive a service establishment response message from the service management function, indicating that the broadcast service has been established in the second broadcast transmission network.

8. The WTRU of claim 7, wherein the at least one lower layer component is configured to perform the handover to the second broadcast transmission network in response to the service establishment response message.

9. The WTRU of claim 6 wherein the at least one lower layer component is configured to performed the handover to the second broadcast transmission network using Institute of Electrical and Electronics Engineers (IEEE) Media Independent Handover (MIH) technology.

10. The WTRU of claim 6 wherein the first broadcast transmission network or the second broadcast transmission network is based on Digital Video Broadcasting-Handheld (DVB-H) technology, MediaFLO technology, or Multimedia Broadcast Multicast Service (MBMS) technology, and wherein the second broadcast transmission network is based on DVB-H technology, MediaFLO technology, or MBMS technology.

11. A method for use in a wireless transmit/receive unit (WTRU), the method comprising:
receiving a broadcast service via a first broadcast system;
displaying data from the broadcast service in a first media application based on broadcast service configuration data related to the first broadcast system;
performing a handover from the first broadcast system to a second broadcast system, wherein the second broadcast system is based on a different technology from the first broadcast system;
receiving the broadcast service via the second broadcast system; and
displaying data from the broadcast service in a second media application based on broadcast service configuration data related to the second broadcast system.

12. The method of claim 11, wherein the broadcast service configuration data related to the first broadcast system or the broadcast service configuration data related to the second broadcast system indicates one or more of: a video encapsulation format;
a video codec; a frame rate; or an audio codec.

13. The method of claim 11, further comprising:
transferring user context data from the first media application to the second media application, wherein the user context data;
wherein the displaying data from the broadcast service in the second media application is further based on the user context data.

14. The method of claim 13, wherein the user context data indicates one or more of: bookmarks set by a user; whether subtitles are required for the broadcast service; or a language in which subtitles are required for the broadcast service.

15. The method of claim 11, wherein the first broadcast system or the second broadcast system is based on Digital Video Broadcasting-Handheld (DVB-H) IP Datacast (IPDC) technology, Open Mobile Alliance (OMA) Mobile Broadcast Services Enabler Suite (BCAST) technology, or MediaFLO technology.
